(19) United States
(12) Patent Application Publication
(10) Pub. No.: US 2014/0252119 A1
(43) Pub. Date: Sep. 11, 2014

(54) Synthetic Jet Actuator Equipped With A Piezoelectric Actuator And A Viscous Seal

(71) Applicant: Nuventix, Inc., Austin, TX (US)

(72) Inventors: Jim Balthazar, Austin, TX (US); Raghavendran Mahalingam, Austin, TX (US)

(73) Assignee: Nuventix, Inc., Austin, TX (US)

(21) Appl. No.: 14/193,149

(22) Filed: Feb. 28, 2014

Related U.S. Application Data
(60) Provisional application No. 61/770,707, filed on Feb. 28, 2013.

(51) Int. Cl. F04B 17/00; B05B 17/06

(52) U.S. Cl. CPC F04B 17/003; B05B 17/0615
USPC 239/102.2; 417/410.2

(57) ABSTRACT

A synthetic jet ejector (201) is provided which includes a housing (203). A blade (205) is disposed in the housing which has a first fixed end (207) and a second movable end (209), and which is driven by an actuator to trace out a first volume as its free end moves between a first apex and a second apex. The housing has a first portion which is spaced apart from, and complimentary in shape to, at least a portion of the first volume. The spacing (217) between this volume and the first portion is sufficiently small to form a viscous seal around the periphery of the actuator.

### CROSS-REFERENCE TO RELATED APPLICATION

This application claims the benefit of priority from U.S. provisional application No. 61/770,707, filed Feb. 28, 2013, having the same title, and the same inventors, and which is incorporated herein by reference in its entirety.

### FIELD OF THE DISCLOSURE

The present disclosure relates generally to synthetic jet ejectors, and more particularly to a synthetic jet ejector equipped with a piezoelectric actuator and a viscous seal.

### BACKGROUND OF THE DISCLOSURE

A variety of thermal management devices are known to the art, including conventional fan based systems, piezoelectric systems, and synthetic jet ejectors. The latter type of system has emerged as a highly efficient and versatile thermal management solution, especially in applications where thermal management is required at the local level.

Various examples of synthetic jet ejectors are known to the art. Earlier examples are described in U.S. Pat. No. 5,758,823 (Glezer et al.), entitled “Synthetic Jet Actuator and Applications Thereof”; U.S. Pat. No. 5,894,990 (Glezer et al.), entitled “Synthetic Jet Actuator and Applications Thereof”; U.S. Pat. No. 5,988,522 (Glezer et al.), entitled Synthetic Jet Actuators for Modifying the Direction of Fluid Flows”; U.S. Pat. No. 6,056,204 (Glezer et al.), entitled “Synthetic Jet Actuators for Mixing Applications”; U.S. Pat. No. 6,123,145 (Glezer et al.), entitled Synthetic Jet Actuators for Cooling Heated Bodies and Environments”; and U.S. Pat. No. 6,588,497 (Glezer et al.), entitled “System and Method for Thermal Management by Synthetic Jet Ejector Channel Cooling Techniques”.

Further advances have been made in the art of synthetic jet ejectors, both with respect to synthetic jet ejector technology in general and with respect to the applications of this technology. Some examples of these advances are described in U.S. 20100263838 (Mahalingam et al.), entitled “Synthetic Jet Ejector for Augmentation of Pumped Liquid Loop Cooling and Enhancement of Pool and Flow Boiling”; U.S. 20100039012 (Grimm), entitled “Advanced Synjet Cooler Design For LED Light Modules”; U.S. 20100033071 (Heffington et al.), entitled “Thermal management of LED Illumination Devices”; U.S. 20090141065 (Darbin et al.), entitled “Method and Apparatus for Controlling Diaphragm Displacement in Synthetic Jet Actuators”; U.S. 20090109625 (Booth et al.), entitled Light Fixture with Multiple LEDs and Synthetic Jet Thermal Management System“; U.S. 20090084866 (Grimm et al.), entitled Vibration Balanced Synthetic Jet Ejector”; U.S. 20080295997 (Heffington et al.), entitled Synthetic Jet Ejector with Viewing Window and Temporal Aliasing”; U.S. 20080219007 (Heffington et al.), entitled “Thermal Management System for LED Array”; U.S. 20080151541 (Heffington et al.), entitled “Thermal Management System for LED Array”; U.S. 20080043061 (Glezer et al.), entitled “Methods for Reducing the Non-Linear Behavior of Actuators Used for Synthetic Jets”; U.S. 20080009187 (Grimm et al.), entitled “Moldable Housing design for Synthetic Jet Ejector”; U.S. 20080006393 (Grimm), entitled Vibration Isolation System for Synthetic Jet Devices”; U.S. 20070272393 (Reichenbach), entitled “Electronics Package for Synthetic Jet Ejectors”; U.S. 20070141453 (Mahalingam et al.), entitled “Thermal Management of Batteries using Synthetic Jets”; U.S. 20070096118 (Mahalingam et al.), entitled “Synthetic Jet Cooling System for LED Module”; U.S. 20070081027 (Beltran et al.), entitled “Acoustic Resonator for Synthetic Jet Generation for Thermal Management”; U.S. 20070023169 (Mahalingam et al.), entitled “Synthetic Jet Ejector for Augmentation of Pumped Liquid Loop Cooling and Enhancement of Pool and Flow Boiling”; U.S. 20070119573 (Mahalingam et al.), entitled “Synthetic Jet Ejector for the Thermal Management of PCI Cards”; U.S. 20070119575 (Glezer et al.), entitled “Synthetic Jet Heat Pipe Thermal Management System”; U.S. 20070127210 (Mahalingam et al.), entitled “Thermal Management System for Distributed Heat Sources”; U.S. 20070141453 (Mahalingam et al.), entitled “Thermal Management of Batteries using Synthetic Jets”; U.S. Pat. No. 7,252,140 (Glezer et al.), entitled “Apparatus and Method for Enhanced Heat Transfer”; U.S. Pat. No. 7,606,029 (Mahalingam et al.), entitled “Thermal Management System for Distributed Heat Sources”; U.S. Pat. No. 7,607,470 (Glezer et al.), entitled “Synthetic Jet Heat Pipe Thermal Management System”; U.S. Pat. No. 7,760,499 (Darbin et al.), entitled “Thermal Management System for Card Cages”; U.S. Pat. No. 7,768,779 (Heffington et al.), entitled “Synthetic Jet Ejector with Viewing Window and Temporal Aliasing”; U.S. Pat. No. 7,784,972 (Heffington et al.), entitled “Thermal Management System for LED Array”; and U.S. Pat. No. 7,819,556 (Heffington et al.), entitled “Thermal Management System for LED Array”.

### BRIEF DESCRIPTION OF THE DRAWINGS

FIGS. 1A-1C are illustrations depicting the manner in which a synthetic jet actuator operates.

FIG. 2 is a side view of a first embodiment of a synthetic jet ejector in accordance with the teachings herein, which is equipped with a piezoelectric actuator (the range of motion of which is indicated by dashed lines) and a viscous seal.

FIG. 3 is a cross-sectional view of the synthetic jet ejector of FIG. 2 taken along LINE 3-3 of FIG. 2, and depicting the viscous seal formed between the periphery of the actuator and the housing.

### SUMMARY OF THE DISCLOSURE

In one aspect, a synthetic jet ejector is provided which comprises (a) a housing; and (b) a piezoelectric actuator disposed in said housing, said piezoelectric actuator having a first fixed end and a second movable end; wherein said piezoelectric actuator operates to trace out a first volume as its free end moves between a first apex and a second apex, wherein said housing has a first portion which is spaced apart from, and complimentary in shape to, said first volume, and wherein the spacing between said volume and said first portion is sufficiently small to form a viscous seal around the periphery of said actuator.

### DETAILED DESCRIPTION

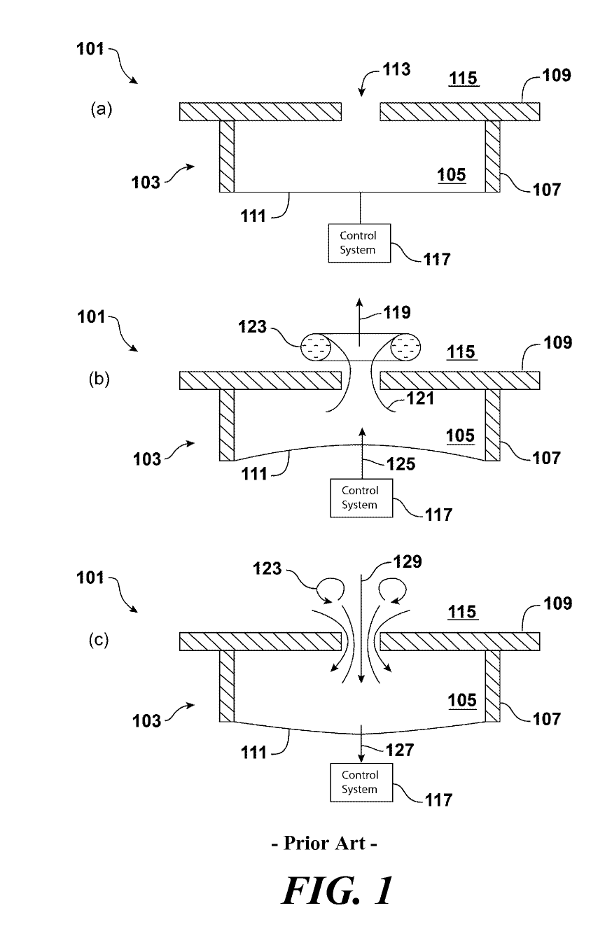

The structure of a synthetic jet ejector may be appreciated with respect to FIG. 1a. The synthetic jet ejector 101 depicted therein comprises a housing 103 which defines and encloses an internal chamber 105. The housing 103 and chamber 105 may take virtually any geometric configuration, but for purposes of discussion and understanding, the housing 103 is shown in cross-section in FIG. 1a to have a rigid side wall 107, a rigid front wall 109, and a rear diaphragm 111 that is flexible to an extent to permit movement of the diaphragm 111 inwardly and outwardly relative to the chamber 105. The front wall 109 has an orifice 113 therein which may be of various geometric shapes. The orifice 113 diametrically opposes the rear diaphragm 111 and fluidically connects the internal chamber 105 to an external environment having ambient fluid 115.

The movement of the flexible diaphragm 111 may be controlled by any suitable control system 117. For example, the diaphragm may be moved by a voice coil actuator. The diaphragm 111 may also be equipped with a metal layer, and a metal electrode may be disposed adjacent to, but spaced from, the metal layer so that the diaphragm 111 can be moved via an electrical bias imposed between the electrode and the metal layer. Moreover, the generation of the electrical bias can be controlled by any suitable device, for example but not limited to, a computer, logic processor, or signal generator. The control system 117 can cause the diaphragm 111 to move periodically or to modulate in time-harmonic motion, thus forcing fluid in and out of the orifice 113.

Alternatively, a piezoelectric actuator could be attached to the diaphragm 111. The control system would, in that case, cause the piezoelectric actuator to vibrate and thereby move the diaphragm 111 in time-harmonic motion. The method of causing the diaphragm 111 to modulate is not particularly limited to any particular means or structure.

The operation of the synthetic jet ejector 101 will now be described with reference to FIGS. 1b-FIG. 1c. FIG. 1b depicts the synthetic jet ejector 101 as the diaphragm 111 is controlled to move inward into the chamber 105, as depicted by arrow 125. The chamber 105 has its volume decreased and fluid is ejected through the orifice 113. As the fluid exits the chamber 105 through the orifice 113, the flow separates at the (preferably sharp) edges of the orifice 113 and creates vortex sheets 121. These vortex sheets 121 roll into vortices 123 and begin to move away from the edges of the orifice 109 in the direction indicated by arrow 119.

FIG. 1c depicts the synthetic jet ejector 101 as the diaphragm 111 is controlled to move outward with respect to the chamber 105, as depicted by arrow 127. The chamber 105 has its volume increased and ambient fluid 115 rushes into the chamber 105 as depicted by the set of arrows 129. The diaphragm 111 is controlled by the control system 117 so that, when the diaphragm 111 moves away from the chamber 105, the vortices 123 are already removed from the edges of the orifice 113 and thus are not affected by the ambient fluid 115 being drawn into the chamber 105. Meanwhile, a jet of ambient fluid 115 is synthesized by the vortices 123, thus creating strong entrainment of ambient fluid drawn from large distances away from the orifice 109.

Despite the many advances in synthetic jet ejector technology, a need for further advances in this technology still exists. For example, there is a need in the art for synthetic jet ejectors having a simplified construction, and which may be mass produced at low cost. It has now been found that the foregoing needs may be addressed with a synthetic jet ejector of the type disclosed herein.

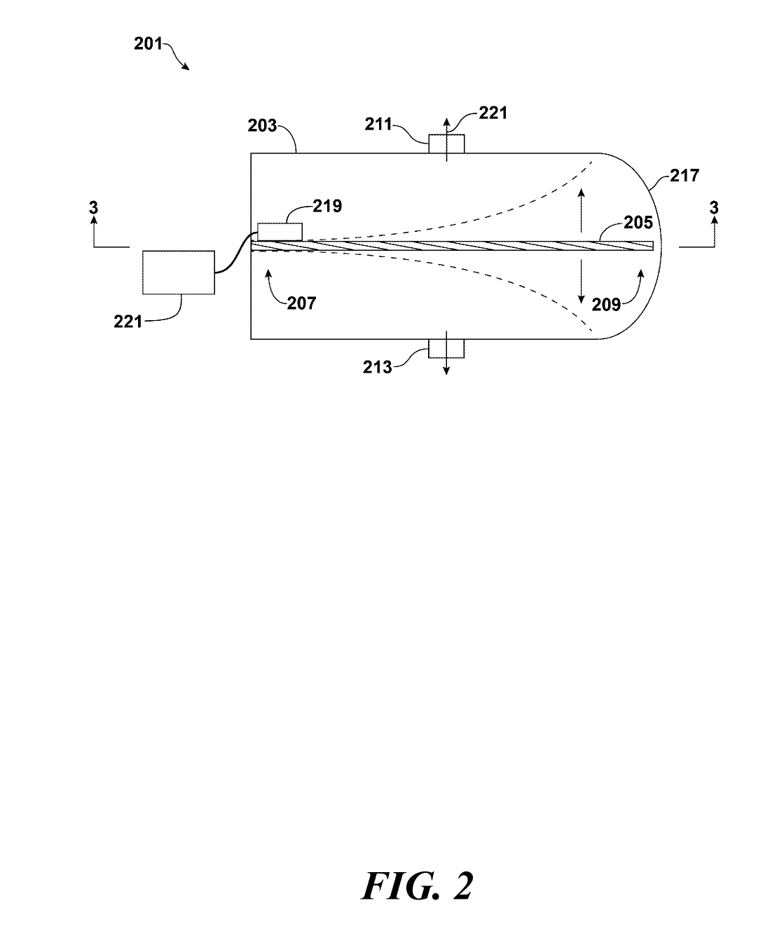

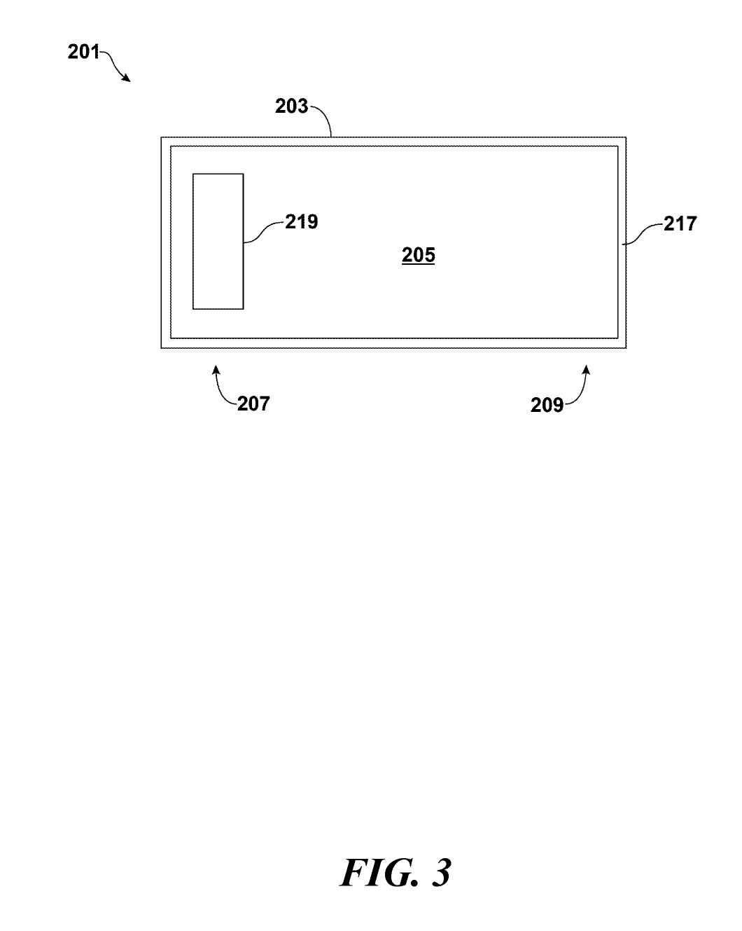

FIGS. 2-3 are illustrations of a first particular, non-limiting embodiment of a synthetic jet ejector in accordance with the teachings herein. As seen therein, the synthetic jet ejector 201 comprises a housing 203 with a blade 205 or diaphragm disposed therein. The blade 205 is driven by an actuator 219, which is preferably a piezoelectric actuator, and is fixed at a first end 207 thereof and movable at a second (preferably opposing) end 209 thereof. The periphery of the blade 205 is spaced apart from the housing 203. The housing 203 is equipped with a first aperture 211 disposed on a first side of the blade 205, and a second aperture 213 disposed on a second side of the blade 205.

In use, the blade 205 traces out a volumetric shape as indicated by the dashed lines in FIG. 2. The housing 203 has a first portion 215 which is spaced apart from, and complimentary in shape to, said first volume. This spacing 217 (see FIG. 3) is small enough to create a viscous seal between the piezoelectric actuator 205 and the housing 203 when the synthetic jet ejector 201 is in operation. Consequently, formation of a synthetic jet 221 is enabled at the first 211 and second 213 apertures.

Although the blade 205 is depicted in FIG. 3 as having a rectangular shape, it will be appreciated that it may have a wide variety of shapes, including shapes which are circular, elliptical, polygonal or irregular. Similarly, the housing 203 may also have a variety of shapes, although the housing 203 is preferably complimentary in cross-sectional shape to the actuator along at least the range of motion of the second end 209 thereof

Various actuators 219 may be utilized in the devices described herein to drive or oscillate the blade 205, although the use of piezoelectric actuators is preferred. In a piezoelectric actuator such as that depicted in FIG. 2, the actuator 219 comprises a piezoelectric material (typically, a piezo-ceramic material) which is attached to the blade and which receives power from a control module 221 or power source to drive the blade 205. Many different piezoelectric materials and piezoelectric actuators are known to the art, and may be utilized in the devices and methodologies described herein. These include, without limitation, barium titanate (BaTiO₃), lead titanate (PbTiO₃), lead zirconate titanate (Pb[ZrₓTi₁₋ₓ]O₃ 0≦x≦1), potassium niobate (KNbO₃), lithium niobate (LiNbO₃), lithium tantalate (LiTaO₃), sodium tungstate (Na₂WO₃), zinc oxide (ZnO), Ba₂NaNb₅O₅, Pb₂KNb₅O₁₅, sodium potassium niobate ((K,Na)NbO₃), bismuth ferrite (BiFeO₃), sodium niobate (NaNbO₃), bismuth titanate (Bi₄Ti₃O₁₂), sodium bismuth titanate (Na_{0.5}Bi_{0.5}TiO₃), and piezoelectric polymers such as, for example, polyvinylidene fluoride (PVDF).

Various materials may be utilized in the blades described herein. Such materials include, without limitation, various metals, polymeric materials (such as, for example, nylon resins), ceramics, and fibrous masses or papers. One skilled in the art will appreciate that the particular choice of materials may depend on the end use, the choice of actuator or piezoelectric material, the size of the blade required, and other such considerations.

The spacing between the housing and the blade required to achieve a fluidic seal may vary depending, for example, on the choice of ambient fluid, the viscosity of the ambient fluid, the frequency at which the blade is being driven, and other such factors that will be apparent to one skilled in the art. However, the spacing is chosen to be sufficiently small, based on these factors, so that the flow of fluid between the blade and the housing is small or negligible compared to the volumetric flow into or out of the housing during each cycle. In some applications, the spacing may be within in the range of about 1 mm to about 50 mm, within in the range of about 2 mm to about 25 mm, or within in the range of about 5 mm to about 10 mm.

The above description of the present invention is illustrative, and is not intended to be limiting. It will thus be appreciated that various additions, substitutions and modifications may be made to the above described embodiments without departing from the scope of the present invention. Accordingly, the scope of the present invention should be construed in reference to the appended claims.

What is claimed is:

1. A synthetic jet ejector, comprising:
a housing;
a blade disposed in said housing, said blade having a first fixed end and a second movable end; and
an actuator disposed on said blade;
wherein said actuator oscillates said blade so that said blade traces out a first volume as the second end of said blade moves between a first apex and a second apex, wherein said housing has a first portion which is spaced apart from, and complimentary in shape to, at least a first surface of said first volume, and wherein the spacing between said first volume and said housing is sufficiently small to form a viscous seal around the periphery of said actuator.

2. The synthetic jet ejector of claim 1, further comprising a first aperture in said housing.

3. The synthetic jet ejector of claim 1, further comprising a first aperture in said blade.

4. The synthetic jet ejector of claim 1, wherein said first fixed end is attached to said housing.

5. The synthetic jet ejector of claim 1, wherein said first fixed end and said second movable end are opposing ends of said blade.

6. The synthetic jet ejector of claim 1, wherein said blade divides the interior of said housing into a first volume and a second volume when it is at rest.

7. The synthetic jet ejector of claim 6, further comprising a second aperture, wherein said first aperture is disposed on a first side of said blade, and wherein said second aperture is disposed on a second side of said blade.

8. The synthetic jet ejector of claim 5, wherein said first and second apertures are selected from the group consisting of openings and nozzles.

9. The synthetic jet ejector of claim 1, wherein said first portion of said housing is adjacent to said second end of said blade.

10. The synthetic jet ejector of claim 1, wherein said first portion of said housing is arcuate in shape.
